(19) United States
(12) Patent Application Publication
(10) Pub. No.: US 2008/0302531 A1
(43) Pub. Date: Dec. 11, 2008

(54) Process for recovering oil from subterranean reservoirs

(75) Inventors: Paul Daniel Berger, Sugar Land, TX (US); Christie H. Berger, (US)

Correspondence Address: Paul Daniel Berger, 3014 Deer Creek Drive, Sugar Land, TX, 77478, US

(73) Assignee: OIL CHEM TECHNOLOGIES, SUGAR LAND, TX (US)

(21) Appl. No.: 12/157,107

(22) Filed: Jun. 6, 2008

Related U.S. Application Data
(60) Provisional application No. 60/934,053, filed on Jun. 9, 2007.

(51) Int. Cl. E21B 43/22; C09K 8/584

(52) U.S. Cl. 166/270.1; 507/259; 507/211

(57) ABSTRACT

This invention involves a process for recovering oil from a subterranean reservoir where an injection fluid containing one or more primary surfactants of the structure below along with one or more co-surfactants, solvent and optionally a viscosifier and one or more alkalis injected into one or more injection wells and the oil is recovered from one or more producing wells.

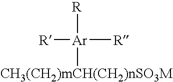

where:
Ar=any aromatic moiety,
M=H, Na, K, Ca, Mg, NH4, or an amine,
m+n=10 to 28,
R, R′, R″=separately and independently H, CH3, branched alkyl having 2-30 carbons, linear alkyl having 2-30 carbons, CH₃(CH₂)ₘCH(CH₂)nSO₃M, O(CH₂CH₂O)ₓH, O(CHCH₃CH₂O)ₓH, or O(CH₂CH₂O)ₐO(CHCH₃CH₂O)_{b}H,
x=1 to 30,
y=1 to 30,
a+b=1 to 30.

The primary surfactant may be prepared in the acid form at one location and shipped as a neat product to be formulated into the final injection brine at or near the point of injection.

### CROSS REFERENCE TO RELATED APPLICATIONS

This application is based on provisional application Ser. No. 60/934,053, filed on Jun. 9, 2007.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of enhanced oil recovery (EOR) and more specifically to a process for recovering oil from subterranean reservoirs.

The present invention describes a new process for the recovery of oil from subterranean petroleum reservoirs using the technique of Enhanced Oil Recovery (EOR), also known as Tertiary Oil Recovery or Improved Oil Recovery (IOR). The introduction of certain surfactant compositions to an oil-bearing formation results in an ultra-low interfacial tension (IFT) between the injection fluid and the crude oil trapped within the microscopic pores of the reservoir, even when the surfactant is at or below its critical micelle concentration (CMC). The present invention comprises injecting into a subterranean oil-containing reservoir a solution containing a primary concentrated surfactant formulation that includes one or more arylalkyl anionic surfactant(s), one or more co-surfactants, optionally one or more alkalis, optionally one or more viscosifiers, and one or more solvents. The oil is then recovered from one or more producing wells.

It is well known that substantial amounts of oil remain in subterranean petroleum reservoirs after primary and secondary recovery processes have been exhausted. Numerous tertiary means of recovering residual oil have been developed, such as adding various chemicals to an aqueous reservoir-flooding medium. U.S. Pat. Nos. 6,022,834, 5,000,262, 4,856,589, 3,882,938 3,520,366, 3,348,611 all describe compositions and processes that have provided improved tertiary oil recovery in selected oil fields with suitable chemical and physical parameters. The oil is recovered from the minute pore spaces in the reservoir rock by introducing an injection solution containing surfactants that reduce the amount of energy required to displace the oil by the injection brine. In many cases a viscosifier such as a synthetic or natural polymer or a gel forming surfactant such as an amphoteric betaine are included in the injection brine to improve the sweep efficiency of the injection brine. Also alkali such as alkali or alkali earth salts including but not limited to sodium hydroxide, sodium carbonate, sodium phosphate, sodium silicate, or sodium meta-borate are added to improve wettability, reduce surfactant adsorption and create “in situ” surfactant by reacting with acidic components in the crude oil.

Some of the weaknesses of surfactants covered by the prior arts include 1) surfactant polymer interference 2) high surfactant adsorption onto the formation, 3) effective concentration ranges of the surfactant is too narrow, 4) higher temperature stability 5) the effectiveness of the surfactant at various alkali concentrations is too narrow, 6) the surfactant is not readily soluble or dispersible in the formation brine, 7) the viscosity of the surfactant is too high making it difficult to handle during the field application 8) the surfactant's stability in the injection system and reservoir conditions is unsuitable. 9) the flash point of the concentrated surfactant is too low creating hazards and additional expenses for transfer, storage, mixing, and special handling equipment, and 10) the surfactant is manufactured from materials that are in short supply and not readily available in the quantities required by a full scale EOR project. Surfactants and processes have been developed to overcome one or more of these deficiencies but the last has continued to present a problem until the composition and process of the present invention.

U.S. Pat. No. 6,043,391 describes a method for producing arylalkyl sulfonates by reacting an olefin sulfonic acid with an aromatic compound and subsequently neutralizing the arylalkyl sulfonic acid formed. We have found these compounds extremely useful when used as the primary surfactant in compositions and processes for EOR. The acid form of these surfactants are stable and therefore can be transported to a site near or at the point of injection where they can be neutralized, blended with other components and injected into the reservoir. This results in a significant savings in the cost of shipping solvent, alkali, water or brine, and polymer, all of which may be obtained locally. In addition the primary surfactant can be produced at an already established location where the proper permits, equipment and technology is already in place avoiding the necessity and difficulty of obtaining local permits and building an infrastructure and manufacturing plant locally. In some cases it may be desirable to build a plant locally or even at the site of injection. This may be the case where large quantities of the primary surfactant are required and economics and logistic favor this alternative. In this case, because of the manufacture of arylalkyl sulfonates does not require an alkylation process and the cost associated with building and operating such a unit, this type of surfactant offers economic, environmental and performance advantages over conventional anionic sulfonates such as alkylaryl benzene sulfonate.

### BRIEF DESCRIPTION OF THE INVENTION

The primary object of the present invention is to provide a process for recovering crude oil from subterranean reservoirs using readily available, low cost raw materials.

Another object of the present invention is to provide a process for the recovery of crude oil from subterranean reservoirs using surfactants that can be easily manufactured and applied to give optimum performance under a wide range of oilfield reservoir environments.

Another object of the present invention is to provide a process for recovering oil from subterranean reservoirs using surfactant compositions that can be used at low concentrations and still provide the low interfacial tensions required to remove residual oil.

A further object of the present invention is to provide a process for the recovery of oil from subterranean reservoirs where the surfactant can be manufactured at or near the injection site to provide improved logistics and savings in transportation costs and taxes.

Yet another object of the present invention is to provide a process for the recovery of crude oil from subterranean reservoirs using a injection composition containing primary surfactants having unique structures that give them superior surfactant properties.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for recovering oil from subterranean reservoirs where an injection fluid comprising the following:

a) one or more arylalkyl sulfonates,

b) one or more co-surfactants,

c) one or more solvents,

d) optionally one or more alkalis,

e) optionally one or more viscosifiers,

is injected into one or more injection wells and the oil is recovered from one or more producing wells. The injection well and the producing well may be the same.

### BRIEF DESCRIPTION OF THE FIGURES

FIG. 1 shows the interfacial tensions obtained using various concentrations of sodium carbonate for three surfactant formulations.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In accordance to the preferred embodiment of the invention there is disclosed process for recovering oil from subterranean reservoirs where an injection fluid comprising the following:
a) one or more primary surfactants
b) one or more co-surfactants,
c) one or more solvents,
d) optionally one or more alkalis,
e) optionally one or more viscosifiers,
   The primary surfactants are aryl alkyl sulfonates having the general structures as below:

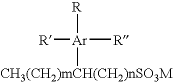

where:
Ar=any aromatic moiety,
M=H, Na, K, Ca, Mg, NH₄, or an amine,
m+n=10 to 28,
R, R′, R″=separately and independently H, CH3, branched alkyl having 2-30 carbons, linear alkyl having 2-30 carbons, CH₃(CH₂)ₘCH(CH₂)ₙSO₃M, O(CH₂CH₂O)ₓH, O(CHCH₃CH₂O)ₓH, or O(CH₂CH₂O)ₐO(CHCH₃CH₂O)_{b}H,
x=1 to 30,
y=1 to 30,
a+b=1 to 30
   When O(CH₂CH₂O)ₐO(CHCH₃CH₂O)_{b}H is present as one or more of R, R′, R″, the order of addition of O(CH₂CH₂O) and O(CHCH₃CH₂O) may be random or in blocks with either appearing first.

Co-surfactants include, but are not limited to, alcohol ethers, alcohol ether sulfates, alcohol ether sulfonates, alkoxylated phenols, alkoxylated phenol sulfates, alkoxylated phenol sulfonates, alkoxylated fatty acids, glucose esters, polyglucosides, phosphate esters, alkyl diphenyl ether sulfonates, amine oxides, sulfosuccinates, olefin sulfonates, alkane sulfonates, alkyl aryl sulfonates, and other surfactants known to impart desirable properties to the formulation by those familiar with the art. Co-surfactants are chosen to act synergistically with the primary surfactant giving lower IFT than the primary surfactant alone and also to broaden the tolerance on the formulation with respect to low IFT over a wider range of total dissolved solids.

Solvents include, but are not limited to, short chained alcohols, glycols, or ethers such as methanol, ethanol, propanol, Isopropanol, butanol, iso-butanol, glycerin, ethylene glycol, propylene glycol, ethylene glycol monobutyl ether.

Solvents are used to adjust the viscosity of the formulation and as compatibility agents to keep all the ingredients in solution,

Alkalis include, but are not limited to, sodium hydroxide, sodium silicate, sodium meta-borate, or sodium carbonate. Alkalis are used to reduced adsorption of surfactant and polymer onto the reservoir rock, to form “in situ” surfactant with acids and acid precursors found in the crude oil, and to modify reservoir wettability.

Viscosifiers include, but are not limited to, any of a number of polymers known to those familiar with the art including polyacrylamide and xanthan gum. Viscosifiers are used to improve volumetric sweep of the injection fluid through the reservoir and to create more favorable mobility ratios.

The above formulation is added to water or synthetic brine or brine that is produced from the reservoir to provide an injection fluid to inject into one or more injection wells and the oil is recovered from one or more producing wells. The one or more injection wells are the same as one or more producing wells. Also the one or more of the injection wells are different from one or more producing wells.

Each component of the injection composition is used at a concentration adequate for its intended use. The typical range of concentrations for each ingredient is shown in Table 1.

TABLE 1
Typical injection composition

| Ingredient | Range, wt % | Preferred range, wt % |
|---|---|---|
| Primary surfactant (s) | 0.025-5.0 | 0.05-2.0 |
| Co-surfactant (s) | 0-5.0 | 0.05-2.0 |
| Polymer | 0-0.35 | 0.5-0.15 |
| Alkali | 0-5.0 | 0-2.0 |
| Solvent (s) | Remainder | Remainder |

### EXAMPLE 1

This example demonstrates the effectiveness of the process using surfactant compositions containing arylalkyl sulfonates and various co-surfactants to reduce IFT over a wide range of crude oil and brine compositions.

Two different field conditions were chosen for testing. The field conditions are summarized in Table 2 and the surfactant formulation and the testing results are shown in Table 3. All values are in weight percent. The IFT was determined using a University of Texas Model 500 Spinning Drop Interfacial Tensiometer. The data shows that ultra low IFT is obtained for different field conditions using and one or more co-surfactants. This is very important in the area of EOR since every field condition is different and treating chemicals must be formulated for each case in order to provide the best results.

A sand pack study was performed by injecting 0.3 Pore Volume (PV) of each of formulations A and B into a column containing crushed formation core saturated with oil from fields A and B respectively each held at the bottom hole temperature as listed in Table 2. The testing protocol was carried out under conditions well known to those familiar with such evaluations. The results from this laboratory sand pack study showed that 56% of the residual oil in place (ROIP) was recovered after water flooding in the case of formulation A and 51% ROIP was recovered in the case of formulation B.

TABLE 2
Field Summary

| | Field A | Field B |
|---|---|---|
| Bottom Hole Temperature | 45° C. | 56° C. |
| Injection Brine, Total Dissolved Solids | 4,675 ppm | 12,000 ppm |
| Di-valent Cations | 95 ppm | 245 ppm |
| Crude Oil API Gravity | 26 | 12 |
| Type Formation | Sandstone | Sandstone |

TABLE 3
Surfactant formulations and IFT Properties

| | Injection | Injection |
|---|---|---|
| Surfactant composition | Fluid A | Fluid B |
| NaC18 arylalkyl xylene sulfonate | 0.15% | — |
| NaC14-16 arylalkyl xylene sulfonate | — | 0.15% |
| NaC13 + 6EO ether sulfate | — | 0.15% |
| NaC1518 Internal Olefin Sulfonate | 0.10% | 0.1% |
| Ethylene glycol monobutyl ether | 0.05% | — |
| Isobutanol | — | 0.05% |
| Partially hydrolyzed polyacrylamide polymer | 0.10% | 0.10% |
| Sodium carbonate | 1.0% | 1.0% |
| Injection Brine | Remainder | Remainder |
| IFT, mN/m | 0.0029 | 0.0068 |
| Residual Oil Recovery (ROIP), % | 56 | 51 |

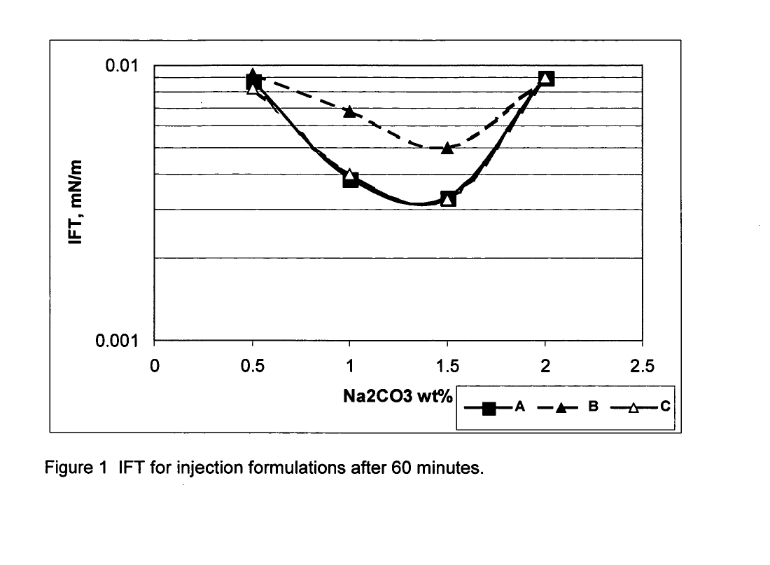

The IFTs obtained for these formulations using various concentrations of sodium carbonate from 0.5 wt % to 2.0 wt % are shown in FIG. 1. Formulation A was used with oil from filed A and formulation B was used for oil from field B. The results demonstrate the wide range of alkali that both these formulations can tolerate and still give ultra-low IFT below 1×10⁻² mN/m.

### EXAMPLE 2

This example demonstrates that, unlike alpha olefin sulfonic acid, internal olefin sulfonic acid, or alcohol ether sulfates; the aryl alkyl sulfonic acid used in the present invention is stable in acid form and therefore can be stored and shipped in concentrated form as the 100% acid and then formulated into the final formulation near the injection site to be injected into the reservoir using the process of this invention. This provide a logistic advantages over other acids used as surfactant intermediates.

C18 aryl alkyl xylene sulfonic acid was prepared by reacting 1-octadecene with sulfur trioxide (SO₃) to form the C18 olefin sulfonic acid. This was further reacted with xylene according to U.S. Pat. No. 6,043,391 to form the C18 arylalkyl xylene sulfonic acid [CAS name 1-octadecenesulfonic acid, (dimethylphenyl)-]. Laboratory monitoring of this material for extended periods over 1 year show this material to be stable and therefore suitable for shipping and storage at ambient conditions between −10° C. and 60° C.

A concentrated surfactant composition was prepared with the ingredients as shown in Table 4. The sodium hydroxide (NaOH) was added to neutralize the C18 arylalkyl xylene sulfonic acid and bring the pH of the sodium salt within the range 6 to 8.

TABLE 4
Concentrated surfactant formulation C

| Ingredient | Weight % |
|---|---|
| C18 aryl alkyl xylene sulfonic acid | 25.0 |
| C13 alcohol ether sulfate | 25.0 |
| NaOH (to neutralize acid) | 6.6 |
| H₂O | 18.4 |
| Ethylene glycol monobutyl ether | 25.0 |

0.2% of the concentrated surfactant formulation was further mixed with 0.1% polymer and 1.2% sodium carbonate in brine. The IFTs were determined for various concentrations of sodium carbonate against field A oil with results comparable to those found for curve A of FIG. 1.

### EXAMPLE 3

This example illustrates the ability to formulate the primary surfactant with other secondary surfactants to obtain low IFT values. The secondary surfactant in this case is the carboxylate of nonylphenol with 10 moles of ethylene oxide (EO). This product is available commercially as Emcol™ CNP-110 from Akzo-Nobel.

A formulation was prepared with the composition shown in Table 5.

TABLE 5
Surfactant/co-surfactant composition

| | Weight % |
|---|---|
| NaC18 aryl alkyl xylene sulfonate | 0.2 |
| Nonylphenol + 10 EO carboxylate | 0.2 |
| Ethylene glycol monobutyl ether | 0.1 |
| Partially hydrolyzed polyacrylamide polymer | 0.1 |
| Injection Brine (un-softened produced water) | Remainder |
| IFT, mN/m, 60 minutes @ 80° C. | 0.0039 |
| Residual Oil Recovery, % | 63% |

This formulation does not require alkali to give low IFT and therefore softening of the brine to prevent precipitation of Calcium and Magnesium salts is not necessary. The IFT at 35° C. after 60 minutes was 0.0039 mN/m and the oil recovery is 63%. The performance using this acid aged more than one year is comparable to the same formulation using a fresh sample of the Na C18 aryl alkyl xylene sulfonate and proves the feasibility of transporting the product in concentrated acid form to provide a logistic advantage.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A process for recovering oil from subterranean reservoirs where an injection fluid comprising the:
a) one or more arylalkyl sulfonates as defined by in structure 1 below, 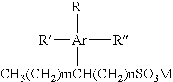
where:
Ar=any aromatic moiety,
M=H, Na, K, Ca, Mg, NH₄, or an amine,
m+n=10 to 28,
R, R′, R″=separately and independently H, CH3, branched alkyl having 2-30 carbons, linear alkyl having 2-30 carbons, CH₃(CH₂)ₘCH(CH₂)ₙSO₃M, O(CH₂CH₂O)ₓH, O(CHCH₃CH₂O)ₓH, or O(CH₂CH₂O)ₐO(CHCH₃CH₂O)_{b}H,
x=1 to 30,
y=1 to 30,
a+b=1 to 30
b) one or more co-surfactants,
c) one or more solvents,
d) optionally one or more alkalis, and;
e) optionally one or more viscosifiers.
is injected into one or more injection wells and the oil is recovered from one or more producing wells.

2. The process for recovering oil from subterranean reservoirs as described in claim 1 where the one or more co-surfactants is chosen from the group: anionic surfactants, nonionic surfactants, amphoteric surfactants.

3. The process for recovering oil from subterranean reservoirs as described in claim 1 where the one or more co-surfactants are chosen from the group: alcohol ethers, alcohol ether sulfates, alcohol ether sulfonates, alkoxylated phenols, alkoxylated phenol sulfates, alkoxylated phenol sulfonates, alkoxylated fatty acids, glucose esters, polyglucosides, phosphate esters, alkyl diphenyl ether sulfonates, amine oxides, sulfosuccinates, olefin sulfonates, alkane sulfonates, alkyl aryl sulfonates.

4. The process for recovering oil from subterranean reservoirs as described in claim 1 where the one or more solvents is chosen from the group: water, short-chin alcohol, glycol, glycol ether.

5. The process for recovering oil from subterranean reservoirs as described in claim 1 where the one or more alkalis is the mono or divalent metallic alkali salt.

6. The process for recovering oil from subterranean reservoirs as described in claim 1 where the one or more alkalis is chosen from the group sodium hydroxide, sodium carbonate, sodium phosphate, sodium silicate, sodium meta-borate.

7. The process for recovering oil from subterranean reservoirs as described in claim 1 where the one or more viscosifiers is chosen from the group natural polymers, synthetic polymers, amphoteric surfactants.

8. The process for recovering oil from subterranean reservoirs as described in claim 1 where when O(CH₂CH₂O)ₐO(CHCH₃CH₂O)_{b}H is present as one or more of R, R′, R″, the order of addition of O(CH₂CH₂) and O(CHCH₃CH₂O) may be random or in blocks with either appearing first.

9. The process for recovering oil from subterranean reservoirs as described in claim 1 where one or more injection wells are the same as one or more producing wells.

10. The process for recovering oil from subterranean reservoirs as described in claim 1 where the one or more of the injection wells are different from one or more producing wells.

11. A process for recovering oil from subterranean reservoirs where one or more primary surfactants of the structure: 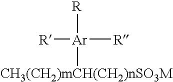
where:
Ar=any aromatic moiety,
M=H
m+n=10 to 28,
R, R′, R″=separately and independently H, CH3, branched alkyl having 2-30 carbons, linear alkyl having 2-30 carbons, CH₃(CH₂)ₘCH(CH₂)ₙSO₃M, O(CH₂CH₂O)ₓH, O(CHCH₃CH₂O)ₓH, or O(CH₂CH₂O)ₐO(CHCH₃CH₂O)_{b}H,
x=1 to 30,
y=1 to 30,
a+b=1 to 30
is neutralized, then compounded with co-surfactants, solvents, optional components into an injection fluid, injected into one or more injection wells and;
the oil is recovered from one or more producing wells.

12. The process for recovering oil from subterranean reservoirs as described in claim 11 where the one or more co-surfactants is chosen from the group: anionic surfactants, nonionic surfactants, amphoteric surfactants.

13. The process for recovering oil from subterranean reservoirs as described in claim 11 where the one or more co-surfactants are chosen from the group: alcohol ethers, alcohol ether sulfates, alcohol ether sulfonates, alkoxylated phenols, alkoxylated phenol sulfates, alkoxylated phenol sulfonates, alkoxylated fatty acids, glucose esters, polyglucosides, phosphate esters, alkyl diphenyl ether sulfonates, amine oxides, sulfosuccinates, olefin sulfonates, alkane sulfonates, alkyl aryl sulfonates.

14. The process for recovering oil from subterranean reservoirs as described in claim 11 where the one or more solvents is chosen from the group: water, short-chin alcohol, glycol, glycol ether.

15. The process for recovering oil from subterranean reservoirs as described in claim 11 where one or more alkalis is optionally added to the injection fluid.

16. The process for recovering oil from subterranean reservoirs as described in claim 11 where the one or more alkalis is chosen from the group sodium hydroxide, sodium carbonate, sodium phosphate, sodium silicate, sodium meta-borate.

17. The process for recovering oil from subterranean reservoirs as described in claim 11 where the one or more viscosifiers is optionally added to the injection fluid.

18. The process for recovering oil from subterranean reservoirs as described in claim 11 where the one or more viscosifiers is chosen from the group natural polymers, synthetic polymers, amphoteric surfactants.

19. The process for recovering oil from subterranean reservoirs as described in claim 11 where when O(CH₂CH₂O)ₐO(CHCH₃CH₂O)_{b}H is present as one or more of R, R′, R″, the order of addition of O(CH₂CH₂O) and O(CHCH₃CH₂O) may be random or in blocks with either appearing first.

20. The process for recovering oil from subterranean reservoirs as described in claim 11 where one or more injection wells are the same as one or more producing wells.

21. The process for recovering oil from subterranean reservoirs as described in claim 11 where the one or more of the injection wells are different from one or more producing wells.

22. The process for recovering oil from subterranean reservoirs as described in claim 11 where the primary surfactant is neutralized at a location near or at the injection wells prior to addition of other components.

23. The process for recovering oil from subterranean reservoirs as described in claim 11 where the primary surfactant is neutralized at a location near or at the injection wells with an alkali metal salt prior to addition of other components.
